(19) United States
(12) Patent Application Publication
(10) Pub. No.: US 2015/0268686 A1
(43) Pub. Date: Sep. 24, 2015

(54) SOCIAL NETWORKING REDUCING PEAK POWER CONSUMPTION IN SMART GRID

(71) Applicants: University of Florida Research Foundation, Inc., Gainesville, FL (US); Illinois Institute of Technology, Chicago, IL (US)

(72) Inventors: Dapeng Wu, Gainesville, FL (US); Huang Qiuyuan, Gainesville, FL (US); Li Xin, Gainesville, FL (US); Xiang-Yang Li, Gainesville, FL (US); Jing Zhao, Gainesville, FL (US)

(73) Assignees: University of Florida Research Foundation, Inc., Gainesville, FL (US); Illinois Institute of Technology, Chicago, IL (US)

(21) Appl. No.: 14/663,212

(22) Filed: Mar. 19, 2015

Related U.S. Application Data
(60) Provisional application No. 61/955,498, filed on Mar. 19, 2014.

(51) Int. Cl. G05F 1/66; G05B 15/02

(52) U.S. Cl. CPC G05F 1/66; G05B 15/02

(57) ABSTRACT

A method of operating a system to reduce peak power consumption of a plurality of users. The method may comprise forming at least one cluster of the plurality of users based on connections within a social network system between the plurality of users, and energy usage patterns of the plurality of users; and scheduling jobs for at least one user within the at least one cluster to reduce peak power used within the at least one cluster. A method of scheduling jobs that consume power for a cluster of users. The cluster may be formed in part based on connections within a social network system. Membership in a cluster may be further based on energy usage patterns. At least one computer-readable storage medium encoded with executable instructions that cause at least one processor to perform a method for forming a cluster and/or scheduling jobs for users within the cluster.

### CROSS-REFERENCE TO RELATED APPLICATIONS

The present application claims the benefit under 35 U.S.C. §119(e) of U.S. Provisional Patent Application No. 61/955,498, entitled “SOCIAL NETWORKING REDUCING PEAK POWER CONSUMPTION IN SMART GRID,” filed Mar. 19, 2014, which is incorporated herein by reference in its entirety.

### BACKGROUND

Energy consumption in buildings represents approximately 74% of the nation's electricity consumption [1]. However, electricity consumption is not efficient in most households, which results in waste of billions of dollars. To reduce the cost of power consumption by households and power generation by utility companies, techniques for scheduling jobs of electrical appliances have been proposed [2, 3]; to make it work, each electrical appliance is equipped with a Demand Response Switch (DRS) device and can be switched on/off by the DRS device [3], and all the DRS devices follow scheduling commands from a scheduler. These techniques seek to reduce the peak power consumption of users, since doing so can help reduce the fluctuation of power consumption, thereby improving the reliability of smart power grids, and reducing the power generation cost incurred by start-up/termination of power generators [4].

Another benefit of reducing the peak power consumption of users is that it may also reduce the payment of users if the utility company charges users based on the peak power consumption as well as the total energy consumption, which is a widely adopted utility cost paradigm in smart grids [3]. Hence, reducing the peak power consumption of users can be a win-win situation for both utility companies and the electricity users.

However, minimizing the peak power consumption of schedulable jobs of electrical appliances of users under delay requirements can be non-deterministic polynomial-time hard (NP hard) [3].

### SUMMARY

Some embodiments provide a method of operating a system to reduce peak power consumption of a plurality of users. The method may comprise forming at least one cluster of the plurality of users based on connections within a social network system between the plurality of users, and energy usage patterns of the plurality of users; and scheduling jobs for at least one user within the at least one cluster to reduce peak power used within the at least one cluster.

In some embodiments, there is provided at least one computer-readable storage medium encoded with executable instructions that, when executed by at least one processor, cause the at least one processor to perform a method for reducing peak power consumption of a plurality of users. The method may comprise participating in formation of a cluster from the plurality of users by sending energy usage patterns of a first user of the plurality of users to at least one second user of the plurality of users, and receiving energy usage patterns of the at least one second user, wherein the formation of the cluster is based on connections between the first user and the at least one second user within a social network system, and the energy usage patterns of the first user and the energy usage patterns of the at least one second user; and scheduling at least one job for the first user to reduce peak power used within the cluster.

Further embodiments provide a method for reducing peak power consumption of a plurality of users. The method may comprise participating in formation of a cluster from the plurality of users by sending energy usage patterns of a first user of the plurality of users to at least one second user of the plurality of users, and receiving energy usage patterns of the at least one second user, wherein the formation of the cluster is based on connections between the first user and the at least one second user within a social network system, and the energy usage patterns of the first user and the energy usage patterns of the at least one second user; and scheduling at least one job for the first user to reduce peak power used within the cluster.

Additional embodiments provide a method of scheduling jobs that consume power for a cluster of users. The cluster may be formed in part based on connections within a social network system. Membership in a cluster may be further based on energy usage patterns. For example, a cluster may be formed to provide low variance of total power usage. Formation of a cluster and/or scheduling of jobs for users in a cluster may be performed at a centralized computing facility or may be distributed over multiple computing devices. For example, such processing may be performed in users' computers.

Accordingly, in some embodiments, there is provided at least one computer-readable storage medium encoded with executable instructions that, when executed by at least one processor, cause the at least one processor to perform a method for forming a cluster and/or scheduling jobs for users within the cluster.

Further embodiments provide a distributed method of forming a cluster and/or scheduling jobs for users within the cluster.

The foregoing is a non-limiting summary of the invention, which is defined by the attached claims.

### BRIEF DESCRIPTION OF THE DRAWINGS

FIG. 1 is a diagram illustrating a social network, a cluster, and a smart grid in which some embodiments of the invention may be implemented.

FIG. 2 is a flowchart of an exemplary method of forming clusters (or groups) and scheduling jobs within those clusters according to some embodiments of the invention.

FIG. 3 is a flowchart of an exemplary method of scheduling jobs according to some embodiments of the invention.

FIG. 4 is a diagram illustrating a computer system on which some embodiments of the invention may be implemented.

FIG. 5 is a chart illustrating power spectral density of real-world household electricity consumption and simulated household electricity consumption according to some embodiments.

FIG. 6 is a chart illustrating energy consumption and payment without using clustering and job scheduling as described herein.

FIG. 7 is a chart illustrating energy consumption and payment while using clustering and job scheduling as described herein.

FIG. 8 is a chart illustrating fuel cost for one million houses in each hour according to some embodiments.

FIG. 9 is a chart illustrating peak power to average power ratio and user payment versus cluster size constraint according to some embodiments.

FIG. 10 is a chart illustrating peak power to average power ratio for minimum variance clustering versus random clustering according to some embodiments.

FIG. 11 is a chart illustrating payment for minimum variance clustering versus random clustering according to some embodiments.

FIG. 12 is a chart illustrating power consumption of a cluster with (a) scheduling and (b) no scheduling for one case according to some embodiments.

FIG. 13 is a chart illustrating power consumption of a cluster with (a) scheduling and (b) no scheduling for another case according to some embodiments.

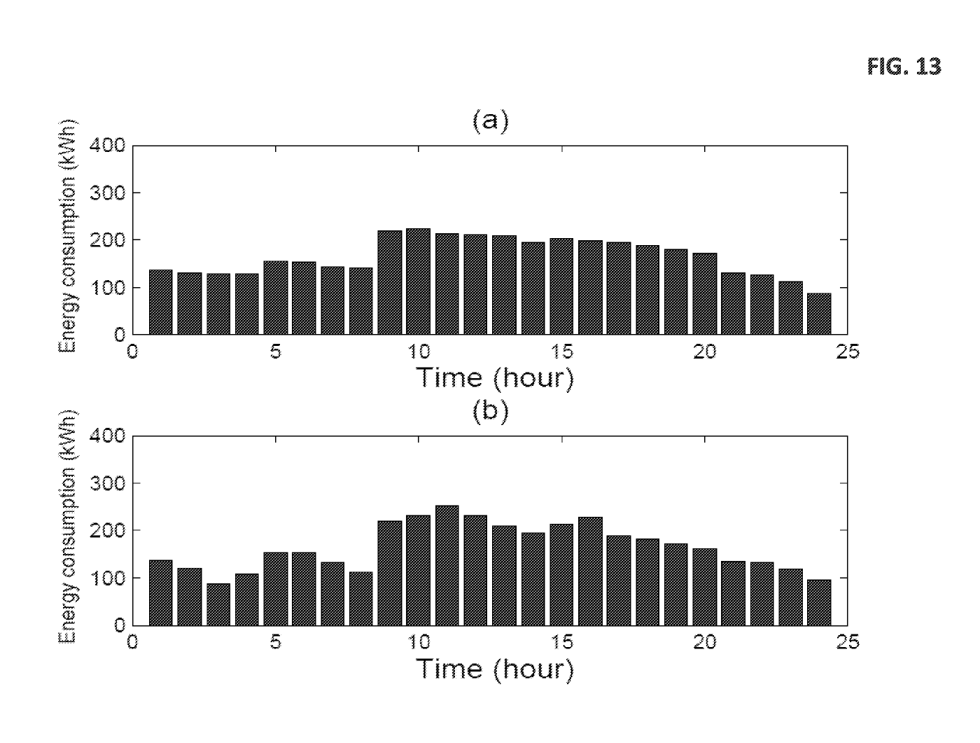

### DETAILED DESCRIPTION

The inventors have recognized and appreciated that peak power consumption can be reduced in an effective and computationally efficient way by scheduling jobs of individually controllable families (or other units) in each of multiple clusters. The clusters may be formed based on connections within a social network.

Scheduling jobs of all units served by a utility company may lead to a lower peak demand, but it may incur a larger communication overhead and managerial cost. To address this, a divide-and-conquer approach may be used, i.e., divide users into small clusters and then schedule/shift jobs to lower the peak power consumption of each cluster, which may attain a good balance between overhead and reduction in the Peak power to Average power Ratio (PAR).

The inventors have recognized and appreciated that to partition users into clusters, a distributed clustering scheme may be advantageous because it may leverage the social network topology of users and the statistical energy usage patterns of users. One reason for this is that when users are socially connected (i.e., being friends of each other), they may be willing to join the same cluster and cooperatively schedule jobs of their electrical appliances to reduce peak power consumption and save costs. In some illustrative embodiments, each user/node only shares its statistical energy usage patterns with its trusted friends/nodes who are also users of the same utility company; these trusted nodes may be called “socially connected” nodes of this user. This trusted friendship forms a social network or graph. Online social networks such as Facebook and Twitter may be used to create such a social graph. However, any suitable technology may be used to create such a social network using known computing devices and networking hardware and software components.

Given a social graph, the clustering scheme according to some embodiments aims at finding clusters of users such that the total power consumption in each cluster of users (which are socially connected) achieves minimum variance. That is, in accordance with some embodiments, users having negative covariance of power consumption patterns may be clustered. Such clustering may lead to a natural leveling of the power consumption of users within a cluster as negative covariance of users implies that their periods of high power consumption are less likely to overlap (or synchronize). Because it may be difficult to manage a large cluster and schedule jobs of users in a large cluster, the clustering scheme according to some embodiments also may consider the constraint on the maximum number of users allowed in a cluster. Different from the spectral clustering algorithms for graph partitioning [6], which are centralized, the clustering algorithm according to some embodiments may be distributed. The distributed computing may be performed on any suitable computing devices, including computing devices of individual units for which scheduling may be performed.

Similar to distributed consensus protocols [7], in some embodiments, the distributed clustering algorithm may use only local information exchange with the aim of achieving global optimality, i.e., finding clusters with minimum variance. However, it should be appreciated that, in other embodiments, global optimality may not be required and a system may use any suitable clustering approach, even if it may provide less reduction in power consumption.

Once users are clustered, jobs for the clusters and members of the clusters may be scheduled in each of multiple scheduling periods. In some embodiments, given users' jobs to be scheduled in the next scheduling period, an approximation algorithm may be used to minimize the peak power consumption of each cluster of users. The approximation algorithm may be called Earliest Deadline First (EDF). According to some embodiments, the EDF scheduling algorithm can be implemented in a distributed manner.

### Implementation of the System

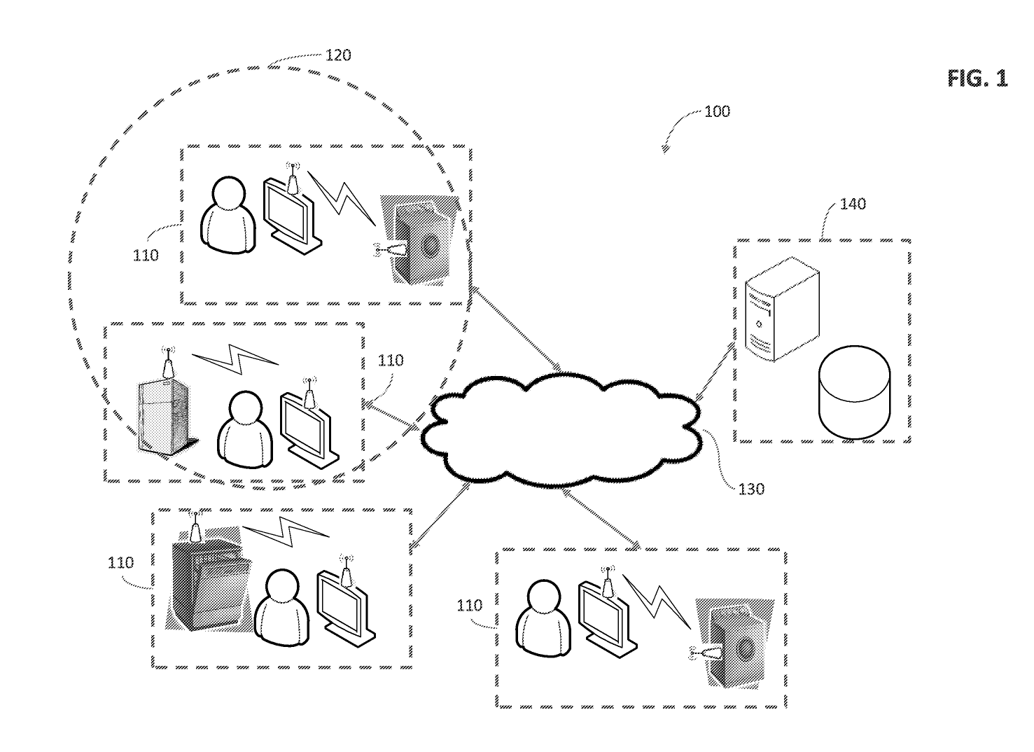

FIG. 1 is a diagram illustrating a system 100 that may employ social network-based scheduling techniques as described herein. In the example of FIG. 1, a number of user premises 110, which in this example are households, consume power and are also connected to a network 130. Here, network 130 may be the Internet. However, any suitable communication technology may be used to communicate among the users. Though not shown for simplicity of illustration, a power distribution network may connect the user premises 110 to power generation facilities.

In system 100, each user premises may be configured using smart grid technology to control schedulable jobs. For example, appliances such as a dryer, dishwasher, or refrigerator in each of the user premises 110 may be controlled to draw power at specific times. These times may be scheduled so that the load on an energy grid supplying power to user premises 110 is distributed over time. In some embodiments, scheduling information may be communicated over network 130, communicated wirelessly to appliances or other devices drawing power, or communicated over power lines.

However, in the illustrated embodiment, each user premises 100 has a computing device that may run a scheduling program to determine execution times for one or more loads at that user premises. Such a computing device may communicate with devices equipped with control hardware as for devices configured to operate on a “smart grid.” In the embodiment illustrated, such communication is wireless, and may be performed over a home network, for example. However, any suitable communication mechanism may be used.

FIG. 1 shows only four user premises. This number of user premises is shown for simplicity of illustration. It should be appreciated that a utility distribution system may have many more users such that scheduling may be performed by distributing power usage within clusters of users. These clusters may be formed by clustering users. For example, a cluster 120 is illustrated.

The clusters may be formed in any suitable way. The clusters may be formed in part based on energy usage patterns of the users. Users may be clustered, for example, to provide clusters with low variance of energy usage over time. Such an energy usage characteristic may indicate a potential for a significant reduction in peak power usage by scheduling to distribute tasks that consume energy.

Additionally, or alternatively, users may be clustered based on a social connection. Clustering users based on a social connection may indicate that users may be willing to cooperate with other users in their cluster to reduce peak power consumption. Cooperation may include, for distributed clustering and scheduling as described herein, exchanging information about current and historical energy usage. Users may be more willing to share such data with other users in their social network than with strangers. In the embodiment illustrated, a social connection may be determined based on connections within a social network. A social network may be implemented using a centralized computing facility 140. However, a social network may be implemented using any suitable computing equipment that can communicate, including distributed computing equipment. A social network may be implemented using such computing equipment with software that allows connections between users based on some affinity between those users. Such social networking systems are known in the art. FACEBOOK, for example, is a widely used platform for implementing social networks. Social networks are formed by users sending and accepting “friend requests.” LINKEDIN is another example of a social network platform. A known social networking platform may be used to identify users within a social network. Though, in some embodiments, a social network may be formed in any suitable way.

It should also be appreciated that a single centralized computing facility is shown for simplicity of illustration. Computing resources implementing a social networking platform and/or smart grid control functions may take any suitable form.

Problem Formulation

For simplicity of explanation, the embodiments herein may consider one utility company and its customers/users. However, in some embodiments techniques as described herein may be applied in scenarios in which more than one utility company is supplying power. It may be assumed that the utility company may have a set U={U₁ U₂, . . . , U_{N}_{ᵤ}} of Nᵤ users. The jobs/appliances of these users may be classified into two types: must-run and schedulable. Must-run appliances may include appliances that “must” be run at some specific time or should not be controlled by a job scheduler. Examples of schedulable appliances include a dish washer and a plug-in electrical vehicle. Some embodiments consider scheduling schedulable appliances/jobs in order to focus on job-scheduler design, although the clustering algorithm may consider the overall power consumption pattern of each user. Some embodiments consider scheduling of jobs that will happen in the next 24 hours. However, the time interval over which scheduling is performed is not critical to the invention and other embodiments may cover any time interval. According to some embodiments, the 24 hours are partitioned into T_{X} time periods, each of which has a length of minutes. For example, T_{L}=10 minutes and then T_{X}=24×60/10=144. Let X_{i,t} denote the sample average (which may be obtained for time slot t by averaging the samples of the same slot t in different days) of (random) total power consumption of all jobs by User i in time slot t. Then the statistical power consumption pattern of User i may be defined by Xᵢ@[X_{i,1}, X_{i,2}, . . . , X_{i,T}_{_{X}}]. For some embodiments, a goal of clustering is to cluster users into clusters such that the variance of power consumption of a cluster may be minimized. Such a minimum-variance clustering can achieve more peak reduction than random clustering of users, in that minimum-variance clustering may tend to place users of different electricity usage patterns into the same cluster; thus the periods of high power consumption of different users may be less likely to overlap, making the peak-minimizing scheduler easy to schedule jobs to achieve low peak demand.

As used herein, “minimized” does not require that an absolute minimum be achieved. Rather, a parameter may be minimized by, to within limits of computational accuracy, performing a process that computes a value that reduces the value of that parameter.

Let Gⱼ denote the set of users in cluster j. Problem 1 may define the minimum variance clustering problem.

Problem 1 (Minimum Variance Clustering Problem).

Consider a set of users U, each user i with a power consumption pattern Xᵢ. Then the minimum variance clustering problem may be to partition users into a collection of clusters {Gⱼ}, such that the maximum variance of clusters is minimized.

$$\begin{matrix}Problem \text{:} Minimum Variance Clustering \\ Objective \text{:} Minimize {max}_{j ∈ \{ 1 , 2 , … , g \}} var ( {𝒢}_{j} ) \\ subject to \text{:} \\ \{ \begin{matrix}1 ) \{ {𝒢}_{1} , {𝒢}_{2} , … , {𝒢}_{K} \} is a partition of 𝒰 , i . e . , {⋃}_{j = 1}^{K} {𝒢}_{j} = 𝒰 \\ 2 ) var ( {𝒢}_{j} ) = {\sum }_{i ∈ {𝒢}_{j}} var ( {P}_{i} ) + {\sum }_{i \neq m ∈ {𝒢}_{j}} 2 cov ( {P}_{i} , {P}_{in} ) , ∀ j\end{matrix}\end{matrix}$$

var(Pᵢ) may be the variance of the power consumption of User i, and can be estimated by sample variance, i.e.,

$$var ( {P}_{i} ) = 1 {T}_{X} {\sum }_{t = 1}^{{T}_{X}} {( {X}_{i , t} )}^{2} - {( 1 {T}_{X} {\sum }_{t = 1}^{{T}_{X}} {X}_{i , t} )}^{2} . \qquad ( 1 )$$

cov(Pᵢ, Pₘ) may be the covariance between the power consumptions of User i and User m, and can be estimated by sample covariance, i.e.,

$$cov ( {P}_{i} , {P}_{m} ) = 1 {T}_{X} {\sum }_{t = 1}^{{T}_{X}} {X}_{i , t} {X}_{m , t} - ( 1 {T}_{X} {\sum }_{t = 1}^{{T}_{X}} {X}_{i , t} ) ( 1 {T}_{X} {\sum }_{t = 1}^{{T}_{X}} {X}_{m , t} ) . \qquad ( 2 )$$

According to some embodiments, the family plan approach for job scheduling may be to partition socially-connected users into small clusters and distributively schedule the jobs of each cluster. It may be called a family plan approach because clustering users may be comparable to each cluster of users joining the same family plan to cooperatively schedule/shift jobs of their electrical appliances with an aim at reducing peak power consumption and saving costs.

Clustering Algorithm

Given a social graph, the clustering algorithm according to some embodiments may aim at finding clusters of users such that the total power consumption in each cluster of users (which are socially connected) achieves minimum variance. Clustering with minimum total co-variance for all pairs of users in the cluster may be equivalent to clustering with minimum variance of the aggregated power consumption pattern of all users in the cluster. It should be appreciated that the latter criterion may imply that the PAR of the cluster is small. For easy management of a family-plan cluster and easy scheduling of jobs of users within the cluster, the clustering algorithm according to some embodiments may limit the maximum number of users allowed in a cluster. The distributed clustering algorithm may only use local information exchange with an aim of achieving global optimality, i.e., finding clusters with minimum variance. Whenever a cluster reaches the maximum size allowed, this cluster of users may stop growing and exit, i.e., it may cease participating in future rounds of finding clusters with minimum variance. The clustering algorithm may terminate when all constrained minimum-variance clusters are found. When the clustering algorithm terminates, each user may be assigned to only one cluster.

Scheduler

Jobs may be scheduled in any suitable way using any suitable information used for scheduling, which may include data on actual energy usage or patterns of usage. Alternatively or additionally, scheduling may be based on information that indirectly indicates job energy usage or job patterns of usage or ability to modify job energy usage over time. Such information may be obtained automatically, such as from sensors recording energy usage or activities correlated to energy usage installed at a user's premises. Alternatively or additionally, information may be obtained via a social network, which may indicate activities of a user as a function of time, for example.

As an example of a scheduling scheme: according to some embodiments, a scheduler is intended to move some jobs from peak hours to off-peak hours so that the peak power consumption in each cluster can be further reduced. Without loss of generality, a discrete time system and a time period [0,T] may be considered, during which N_{J} jobs of electrical appliances, J={J₁, J₂, . . . , J_{N}_{_{T}}} need to be scheduled. Here T may be the length of the scheduling period; typically T may be 24 hours. The i-th job Jᵢ may have a demand profile R parameterized by (dᵢ, τᵢ, τᵢ^{e}, tᵢ^{l}), where dᵢ may denote Jᵢ's average power consumption (although dᵢ may be a function of time for instantaneous power consumption), τᵢ may denote its duration, and to and may denote the earliest and latest starting time of the job, respectively. The starting time sᵢ of the job may satisfy tᵢ^{e}≦sᵢ≦tᵢ^{l}. When the job Jᵢ is scheduled to start at time sᵢ, it may specify a power consumption function Dᵢ (t)=dᵢ·I_{[s}_{ᵢ}_{,s}_{ᵢ}_{+τ}_{ᵢ}_{]}, where I_{[a,b]}(t) may be a step function that may have value 1 at any time slot in interval [a, b] and 0 at any time slot in [0,a) or (b,T]. It may be assumed for some embodiments that the job may not be interrupted once it starts, although interruptible jobs may be used in other embodiments. Under a given schedule, the total load at time t may be

$$D ( t ) @ {\sum }_{i = 1}^{{N}_{J}} {D}_{i} ( t ) = {\sum }_{i = 1}^{{N}_{J}} {d}_{i} \cdot {I}_{[ {s}_{i} , {s}_{i} + {τ}_{i} ]} ( t ) .$$

The scheduler is intended to minimize the peak demand. The problem may be formulated as follows:

Problem 2 (Peak Demand Minimization Problem).

Compute starting time sᵢ for each job Jᵢ to minimize the peak demand D_{Peak}. Then the optimization problem for minimizing peak demand during a finite horizon T>0, may be formulated as:

$$\begin{matrix}Problem \text{:} Peak Demand Minimization Scheduling \\ Objective \text{:} Minimize {D}_{Peak} \\ subject to \text{:} \\ \{ \begin{matrix}( 1 ) D ( t ) {=}^{Δ} {\sum }_{i} {D}_{i} ( t ) = {\sum }_{i = 1}^{{N}_{J}} {d}_{i} {I}_{[ {s}_{i} , {s}_{i} + {τ}_{i} ]} ( t ) \\ ( 2 ) {t}_{i}^{e} \leq {s}_{i} \leq {t}_{i}^{l} , ∀ i \\ ( 3 ) {D}_{Peak} = {max}_{t ∈ [ 0 , T ]} D ( t )\end{matrix}\end{matrix}$$

For the special case that tᵢ^{e}=0 and tᵢ^{l}=T−τᵢ, ∀JᵢεJ, Problem 2 may be NP-hard [3], and so Problem 2 in the general case may also be NP-hard.

Given users' jobs to be scheduled in the next scheduling period, an approximation algorithm called Earliest Deadline First (EDF) may be used (shown in Algorithm 1) to minimize the peak power consumption of each cluster of users according to some embodiments.

Algorithm 1 Earliest Deadline First (Centralized)

| Input: Job profile Dᵢ = (dᵢ, τᵢ, tᵢ^{e}, tᵢ^{l}), ∀ᵢ ∈ {1, ... , Nⱼ}; | |
|---|---|
| parameter a and T. | |
| Output: Job starting time sᵢ, ∀ᵢ ∈ {1, ... , Nⱼ}. | |
| 1: | for each job Jᵢ (i = 1, ... , Nⱼ) do |
| 2: | if τᵢ < T/a then |
| 3: | Put job Jᵢ into the short job set Jₛ; |
| 4: | else |
| 5: | Put job Jᵢ into the long job set J_{I}; |
| 6: | for each job Jᵢ ∈ J_{I} do |
| 7: | sᵢ = tᵢ^{e}; |
| 8: | Sort short jobs Jᵢ ∈ Jₛ in the increasing order of their latest |
| | starting time tᵢ^{l} with a tie break rule that a job of larger power |
| | demand dᵢ comes first; denote the sorted jobs by Jₖ_{₁}, ... , Jₖ_{ₘ}, |
| | where m = \|Jₛ\| and \|Jₛ\| is the cardinality of set Jₛ; |
| 9: | for each job Jₖ_{ᵢ} ∈ Jₛ (i = 1, ... , m) do |
| 10: | if i == 1 then |
| 11: | sₖ_{ᵢ} = tₖ_{ᵢ}^{e}; |
| 12: | else |
| 13: | eₖ_{_{i−1}} = sₖ_{_{i−1}} + τₖ_{_{i−1}}; |
| 14: | if tₖ_{ᵢ}^{l} ≧ eₖ_{_{i−1}} then |
| 15: | sₖ_{ᵢ} = max{eₖ_{_{i−1}}, tₖ_{ᵢ}^{e}}; |
| 16: | else |
| 17: | sₖ_{ᵢ} = tₖ_{ᵢ}^{e}; |

Algorithm 1 can be applied to 1) jobs of a single user and 2) jobs of all the users in one family-plan cluster. In Algorithm 1, jobs may be partitioned into two subsets: long job set Jᵢ and short job set Jₛ; if the job duration τᵢ is less than T/a (a is a user-specified parameter and 1<a≦2), then job Jᵢ may belong to the short job set Jₛ; otherwise, it may belong to the long job set Jₗ. For each long job Jᵢ in Jₗ, it is scheduled to start at its earliest starting time, i.e., sᵢ=tᵢ^{e}. Note that a long job may not be sequentially combined with another long job in the time period [0,T]. That is, once a long job Jᵢ ends, there may not be enough remaining time to run another long job Jₖ because τᵢ+τₖ>T for any long job Jᵢ and any long job Jₖ (i≠k). In contrast, it may be possible to schedule multiple short jobs in a sequential manner if the sum of their durations Σᵢτᵢ is not more than T. For short jobs Jᵢ εJₛ, these jobs may be sorted in the increasing order of their latest starting time tᵢ^{l} (i.e., sorting short jobs from the most urgent job to the least urgent job); if multiple jobs have the same tᵢ^{l}, then these jobs may be further sorted in the decreasing order of their power demand dᵢ. Then the sorted short jobs may be scheduled using a “greedy” algorithm, i.e., with the more urgent job first; if multiple jobs have the same, tᵢ^{l} a job with a larger power demand may be scheduled first. In Step 13 of Algorithm 1, eₖ_{ᵢ₋₁} may denote the end time of job Jₖ_{ᵢ₋₁}.

Different from the centralized Algorithm MP in [3], the EDF algorithm according to some embodiments may be implemented in a distributed manner as follows: each user can exchange information about its jobs (to be scheduled) with other users in the same cluster, and each user can use Algorithm 1 (applied to all the jobs of the users in the same cluster) to find a schedule of its own jobs; each user (in reality, it may be the household control center of each user) may apply the resulting schedule of the jobs (via the DRS devices) to its electrical appliances.

Exemplary Implementation

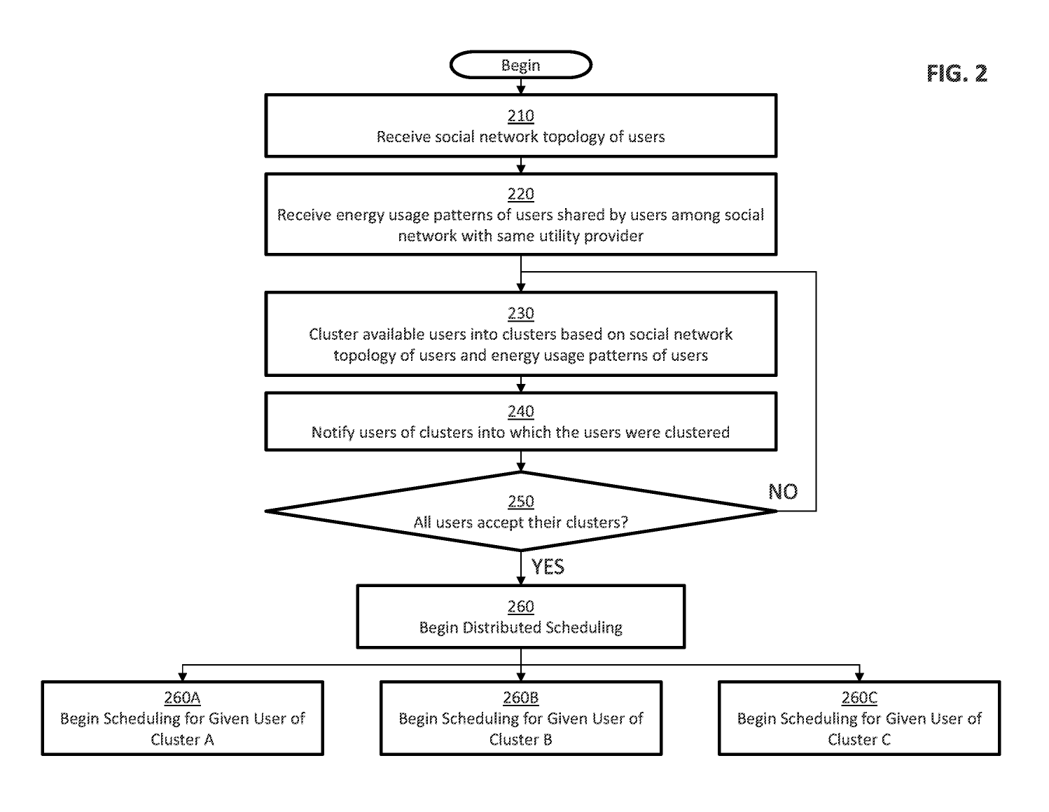

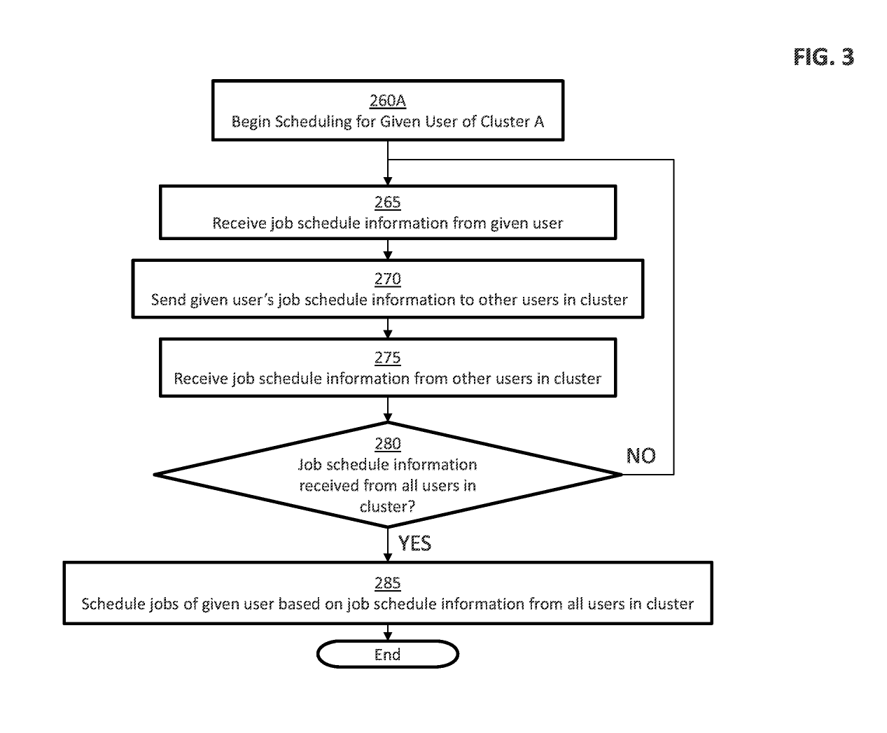

Any customer/user of a given utility company who is willing to participate in the family plans can create an account on Facebook or any other social network. As used herein, “social network” refers to a network of users implemented by the interactions of the users with one or more computing systems. Each of these users can download a matching application of the utility company from the application store of the social network or any other suitable source; this matching application may run Algorithm 3, as shown below, or a similar algorithm. For example, the matching application may receive the social network topology of users as shown in act 210 of FIG. 2. A user may exchange its state vector with its neighbors (e.g., its trusted friends on the social network), in Step 7 of Algorithm 3. For example, the matching application may receive the energy usage patterns of users shared by users among the social network as shown in act 220. The matching application may partition all the users into clusters, and may notify each user of its cluster membership. Act 230 of FIG. 2 shows an example of this. The matching application may notify users of the clusters into which the users were clustered, as shown in the example of act 240. If all users agree with the assigned membership, another algorithm or phase may execute (for example, scheduling, as shown in acts 250 and 260); otherwise, the implementation may remove those clusters who already agreed to the assigned membership and re-run the matching application for the remaining users until all users are assigned cluster memberships, as shown in the example of acts 250 and 230. In the scheduling phase, each user can download a scheduling application from the application store of the social network or any other suitable source. This may allow distributed scheduling, as shown in acts 260A, 260B, and 260C of FIG. 2. Each user may manually enter those jobs that are automatically switched on/off by its DRS devices. Then the scheduling application of each user may exchange information about its jobs (to be scheduled) with the scheduling application of other users in the same cluster, as shown in acts 265, 270, 275, and 280 of FIG. 3. The scheduling application of each user may run Algorithm 1 (applied to all the jobs of the users in the same cluster) and may obtain a schedule of its own jobs, as shown in act 285 of FIG. 3. The scheduling application of each user may then apply the resulting schedule of the jobs (via the DRS devices) to electrical appliances of the user, which may be on the premises of the user.

### Distributed Clustering Scheme

Users may be clustered in any suitable way using any suitable information used for clustering, which may include data on actual energy usage or patterns of usage. Alternatively or additionally, clustering may be based on information that indirectly indicates energy usage or patterns of usage or willingness or ability to modify energy usage over time. Such information may be obtained automatically, such as from sensors recording energy usage or activities correlated to energy usage installed at a user's premises. Alternatively or additionally, information may be obtained via a social network, which may indicate activities of a user as a function of time, for example.

As an example of a clustering scheme: let Pᵢ(t) denote the instantaneous power consumption of User i in time slot t. Let var(X) be the variance of random variable X and cov(X, Y) be the covariance between X and Y. Then the following may be considered:

$$\begin{matrix}Proposition 1. & \\ \{ \begin{matrix}var ( X + Y ) = var ( X ) + var ( Y ) + 2 \times cov ( X , Y ) \\ var ( X + {\sum }_{i} {Y}_{i} ) = var ( X ) + var ( {\sum }_{i} {Y}_{i} ) + {\sum }_{i} 2 cov ( X , {Y}_{i} )\end{matrix} & ( 3 )\end{matrix}$$

From Proposition 1, it may be known that a new user i can be added to a cluster G_{g} of users to further reduce the variance of the power consumption of all users in the cluster if and only if

$$var ( {P}_{i} ) < - {\sum }_{j ∈ {G}_{g}} 2 cov ( {P}_{i} , {P}_{j} )$$

According to some embodiments, a goal is to find a clustering so that the variance of summed power consumption is as small as possible.

Let Gᵤ denote the social graph formed by Nᵤ users; the graph Gᵤ may have a node set Vᵤ and an edge set Eᵤ. |Vᵤ| may denote the cardinality of set Vᵤ. It may be assumed that Nᵤ users may be partitioned into multiple clusters, and the members of cluster j may form a set denoted by Gⱼ. It should be appreciated that var(ΣᵢPᵢ)=Σᵢvar(Pᵢ)+Σ_{i≠j}2cov(Pᵢ, Pⱼ). The minimal variance clustering problem studied here may be reducible to a graph clustering problem: each (user) node iεVᵤ may have a weight var(Pᵢ), and each edge (i, j) has a weight 2cov(Pᵢ, Pⱼ). Then a clustering may be pursued such that the maximum cluster weight (i.e., sum of weights of nodes and edges within the cluster) is minimized. This problem may be NP-hard, as many NP-hard problems may be special cases of this problem (e.g., subset sum problem).

For ease of understanding, a centralized version of the clustering algorithm according to some embodiment is presented in Algorithm 2; then a distributed version of the clustering algorithm according to some embodiments is presented in Algorithm 3.

Algorithm 2 Minimum-Variance Clustering (Centralized)

| Input: Group size constraint Nₑ, social graph Gᵤ, Xᵢ (∀ᵢ ∈ | |
|---|---|
| Vᵤ). | |
| Output: {Gⱼ}. | |
| 1: | for i from 1 to \|Vᵤ\| do |
| 2: | (Initialization) gᵢ = i; |
| 3: | (InitialIzation) σ_{g}_{ᵢ}² = var(Pᵢ); |
| 4: | (Initialization) Gᵢ = {i}; |
| 5: | while \|Vᵤ\| ≠ 0 do |
| 6: | for all i ∈ Vᵤ do |
| 7: | For each distinct gₖ (k ∈ N(i)) and gₖ ≠ gᵢ, calculate |
| | γ_{gk} = var(Pᵢ) + σ_{gk}² + Σ_{m∈Ggk} 2cov(Pᵢ, Pₘ); |
| 8: | Let γᵢ^{min} = min_{k∈N(i)&gk≠gi} γ_{gk}; |
| 9: | k^{a} = arg min_{k∈N(i)&gk≠gi} γ_{gk}; |
| 10: | If γᵢ^{min} < σ_{gi}² then |
| 11: | σ_{gi}² = σ_{gi}² − var(Pᵢ) − Σ_{m∈Ggk\{i}} 2cov(Pᵢ, Pₘ); |
| 12: | Move User i from G_{g} to G_{gka}; |
| 13: | if \|G_{gi}\| == 0 then |
| 14: | Remove G_{gi}; |
| 15: | gᵢ = gₖₐ; |
| 16: | σ_{g}_{ᵢ}² = γᵢ^{min}; |
| 17: | if \|G_{g}_{ₖ}ₐ\| == N_{c} then |
| 18: | Output G_{g}_{ₖ}ₐ and remove all nodes in G_{g}_{ₖ}ₐ and |
| | associated links from graph Gᵤ; |
| 19: | if no change in any group then |
| 20: | Output all groups and remove all nodes and links from |
| | graph Gᵤ |

Algorithm 2 may output clusters of users {Gⱼ}, and the number of clusters may not be an input parameter. Algorithm 2 may be a clustering algorithm that may partition users into K clusters where K may be unknown to the algorithm. This may be different from K-means clustering algorithm and spectral clustering algorithms.

In Algorithm 2, each user/node i may be assigned with a state vector [gᵢ, σ_{g}_{ᵢ}², G_{g}_{ᵢ}], where gᵢ may be the index of the cluster G_{g}_{ᵢ}, to which User i may be assigned, and σ_{g}_{ᵢ}², may be the variance of

$${\sum }_{j ∈ {G}_{{g}_{i}}} {P}_{j} .$$

Let N(i) denote the set of nodes that are neighbors of Node i in graph Gᵤ. var(Pᵢ) can be estimated by Eq. (1) and cov(Pᵢ, Pₘ) can be estimated by Eq. (2).

The following proposition shows that Algorithm 2 has linear complexity.

Proposition 2.

The computational complexity of Algorithm 2 is O(|Eᵤ|).

Proof.

In Algorithm 2, initializing every node with its cluster index may require O(Nᵤ) time. Each iteration of Algorithm 2 may take linear time in the number of edges (O(|Eᵤ|)). At each node i, the algorithm may first cluster the neighbors according to their cluster index, with complexity O(dᵢ), where dᵢ may be the node degree of Node i. The algorithm may then pick the cluster of minimum variance and assign Node i to this cluster, requiring a worst-case time of O(d₁). This process may be repeated at all nodes and hence an overall time may be O(|Eᵤ|) for each iteration. Because the number of iterations may be independent of |Eᵤ|, the overall complexity of Algorithm 2 may be O(|Eᵤ|).

In Algorithm 2, as the number of iterations increases, the number of nodes that finalize their minimum-variance-cluster membership may increase. The inventors have appreciated that irrespective of Nᵤ, 95% of the nodes or more may finalize their cluster membership by the end of the fifth iteration.

In Algorithm 3, each user may know which users are its neighbors. A routing protocol may be in place, which may allow communication between any two users. Each user i may have knowledge of its own electricity usage profile Xᵢ.

Algorithm 3 Minimum-Variance Clustering (Distributed)

```
  Input: Group size constraint N_{c}, social graph Gᵤ, Xᵢ (∀i ∈ Vᵤ).
  Output: { [symbol]   ⱼ}.
```

| | |
|---|---|
| 1: | for each user i (i = 1, . . . , \|Vᵤ\|) do |
| 2: | (Initialization) gₜ = i; |
| 3: | (Initialization) σ_{gt}² = var(Pₜ); |
| 4: | (Initialization) [symbol] ₜ = {i}; |
| 5: | for each user i (i = 1, . . . , \|Vᵤ\|) do |
| 6: | if User i has not finalized its membership with a group then |
| 7: | User i exchanges its state vector [gₜ, σ_{gt}², [symbol] _{gt}] with each of |
| | its neighbors User k (k ∈ [symbol] (i)); |
| 8: | User i requests for Xₘ from User m if m ∈ [symbol] _{g}_{ₖ} (k ∈ |
| | [symbol] (i)) and Xₘ is not stored in the memory of User i; |
| 9: | For each distinct gₖ (k ∈ [symbol] (i)) and gₖ ≠ gₜ, User i |
| | $calculates {γ}_{{g}_{k}} = var ( {P}_{t} ) + {σ}_{{g}_{k}}^{2} + {\sum }_{m ∈ {𝒢}_{{g}_{k}}} 2 cov ( {P}_{t} , {P}_{m} ) ;$ |
| 10: | Let γₜ^{min} = [symbol] |
| 11: | k* = [symbol] |
| 12: | if γₜ^{min} < σ_{g}_{ₜ}² then |
| 13: | ${σ}_{{g}_{t}}^{2} = {σ}_{{g}_{t}}^{2} - var ( {P}_{t} ) - {\sum }_{m ∈ {𝒢}_{{g}_{t}} ∖ \{ t \}} 2 cov ( {P}_{t} , {P}_{m} ) ;$ |
| 14: | User i notifies each of the users in [symbol] _{g}_{ₜ} about its leaving |
| | the group, and sends the new value of σ_{g}_{ₜ}² to these users; |
| 15: | Each of the users in [symbol] _{g}_{ₜ} removes User i from [symbol] _{g}_{ₜ}, and |
| | update the value of σ_{g}_{ₜ}²; |
| 16: | gₜ = g_{k*}; |
| 17: | σ_{g}_{_{k*}}² = γₜ^{min}; |
| 18: | User i notifies each of the users in [symbol] _{g}_{_{k*}} about its joining |
| | the group, and sends the new value of σ_{g}_{_{k*}}² to these |
| | users; |
| 19: | Each of the users in [symbol] _{g}_{_{k*}} add User i to [symbol] _{g}_{_{k*}}, and update |
| | the value of σ_{g}_{_{k*}}²; |
| 20: | if \| [symbol] _{g}_{_{k*}}\| = = N_{c} then |
| 21: | Each of the users in [symbol] _{g}_{_{k*}} finalizes its membership |
| | with [symbol] _{g}_{_{k*}}; |

Algorithm 3 can run in an asynchronous manner to avoid inconsistencies in updating the cluster membership. In an asynchronous manner, in each slot, only one node may be allowed to update its cluster membership based on information collected in the previous slot. There are many ways of choosing a node for update. One method is to use a token. A node may need to have a token to update its cluster membership. The algorithm may select a node and assign a token to this node. After finishing updating, this node may randomly relay the token to one of its neighbors. This relay process may continue until Algorithm 3 terminates. Since clustering may not have stringent delay requirements, the delay caused by asynchronous implementation of Algorithm 3 may be tolerable. In some embodiments, however, the speed of Algorithm 3 may be increased by a synchronous manner.

### Examples Based on Simulated and Measured Data

### Trace-Driven Simulator

Because the available data-sets do not contain electricity usage of a large number of households, simulated data may be used. A trace-driven simulator, which may be based on an Auto-Regressive Moving Average (ARMA) model and an exponential distribution, was used in this example to generate household energy consumption data and job data. The results of using this trace-driven simulator showed significant saving in user payments and fuel cost and a large reduction on peak power consumption due to the family plan scheme according to some embodiments. For example, using the EDF scheduling for clusters of users obtained by the minimum-variance clustering, the user payment may be reduced by 44.7% and the peak power may be reduced by 47.7%, compared to using the EDF algorithm for a single user. As another example, using the family plan scheme according to some embodiments, the user payment may be reduced by 17.8% and the peak power may be reduced by 18.9%, compared to the EDF algorithm for clusters of users obtained by random clustering.

Household Electricity Consumption Simulator

To evaluate the performance of the clustering scheme according to some embodiments, electricity consumption data for a large number of households may be used. Specifically, for each household i, the statistical-average electricity consumption {X_{i,t}} as a function of time t (tε{1,2, . . . , T_{X}}) may be used. However, such data for a large number of households may not be available in the public domain. Such data may be available for six households [8]. On the other hand, the trace-driven simulator may be used to generate simulated {X_{i,t}} for an unlimited number of households. The simulated {X_{i,t}} may be statistically similar to the real-world {X_{i,t}}, i.e., they may have similar probability distribution functions and auto-correlation functions.

It may be assumed that the real-world {X_{i,t}} may be a stationary stochastic process and can be modeled by an autoregressive moving-average (ARMA) process, which may be defined as below [9].

Definition 1.

(ARMA(p,q) Process) The process {Xₜ, t=0, ±1, ±2, . . . } may be said to be an ARMA(p,q) process if {Xₜ} is stationary and if for every t,

$${X}_{t} - {\sum }_{i = 1}^{p} {φ}_{i} {X}_{t - i} = {Z}_{t} + {\sum }_{j = 1}^{q} {θ}_{j} {Z}_{t - j} \qquad ( 4 )$$

where {Zₜ} may be independent, identically distributed Gaussian random variables with zero mean and variance σₙ².

To determine an ARMA model from samples, the orders p, q, parameters {φᵢ}, {θᵢ} and the white noise variance σₙ² may be determined. The problem of determining orders p and q may be a model selection problem. A typical criterion for model selection is Akaike information criterion (AIC). However, for autoregressive models, the AIC may have a tendency to overestimate p. The Bayesian information criterion (BIC) is another criterion, which may attempt to correct the overfitting nature of the AIC. For a zero-mean ARMA(p,q) process, BIC may be given by

$$B I C = ( {N}_{s} - p - q ) ln [ \frac{{N}_{s} {\hat{σ}}_{n}^{2}}{{N}_{s} - p - q} ] + {N}_{s} ( 1 + ln \sqrt{2 π} ) + ( p + q ) ln [ \frac{{\sum }_{t = 1}^{{N}_{s}} {X}_{t}^{2} - {N}_{s} {\hat{σ}}_{n}^{2}}{p + q} ] \qquad ( 5 )$$

where \hat{σ}ₙ² is the maximum likelihood estimate of the white noise variance σₙ², and Nₛ is the number of samples. The BIC provides a consistent order selection procedure in the sense that if the samples {X₁, . . . , X_{N}_{ₛ}} are truly measurements of an ARMA(p,q) process, and if \hat{p} and \hat{q} are the estimated orders found by minimizing the BIC, then \hat{p}→p and \hat{q}→q with probability one as Nₛ→∞. Thus, the order p and q may be determined by minimizing BIC: {\hat{p},\hat{q}}=argₘᵢₙ_{_{p,q}}BIC.

Algorithm 4 shows an exemplary procedure for generating electricity consumption samples of a simulated household. The first part of Algorithm 4 may be to use model selection and parameter estimation to determine the best-fit model and optimal parameter values. The techniques used in Steps 2 and 9 can be found in [9]. The second part may be to use the resulting model to generate simulated electricity consumption process {X_{i,t}}.

Algorithm 4 Household Electricity Consumption Simulator

| Input: Electricity consumption measurements of a real-world | |
|---|---|
| household {X_{i,t}}. | |
| Output: Electricity consumption samples of a simulated | |
| household {\hat{X}_{i,t}}. | |
| 1: | Calculate autocorrelation function (ACF) R(τ) and partial auto- |
| | correlation function (PACF) α(τ), where τ is a time lag; |
| 2: | Determine the model type according to the features of ACF |
| | and PACE. i.e., determine whether it is an AR(p), or MA(q), |
| | or ARMA(p, q) process; |
| 3: | if it is an AR(p) process then |
| 4: | Pick a value for p; |
| 5: | If it is an MA(q) process then |
| 6: | Pick a value for q; |
| 7: | if it is an ARMA(p, q) process then |
| 8: | Pick values for p and q; |
| 9: | Estimate parameters {φᵢ, θⱼ ; i = 1, ..., p; j = 1, .... , q}; |
| 10: | if BIC in Eq. (5) of the model is not minimum then |
| 11: | Go to Step 3; |
| 12: | Use the resulting model to generate samples {\hat{X}_{i,t}}; |

Job Demand Profile Simulator

To evaluate the performance of the scheduler according to some embodiments, job data for a large number of households may be used. Specifically, for each household, the demand profile of each job may be used. Examples of jobs are listed in Table I. The k-th job J_{i,k} of User i, may have a demand profile D_{i,k} parameterized by (d_{i,k}, τ_{i,k}, t_{i,k}^{e}, t_{i,k}^{l}), where d_{i,k} may denote J_{i,k} 's average power consumption, τ_{i,k} may denote its duration, and t_{i,k}^{e} and t_{i,k}^{l} may denote the earliest and latest starting time of the job, respectively. However, such job data for a large number of households may not be available in the public domain. Such job data may be available for six households [8]. A job profile simulator may be used to generate D_{i,k} for an unlimited number of households. It may be desired for the statistical averages of simulated {D_{i,k}} to match {\hat{X}_{i,t}} generated by Algorithm 4, i.e., the expectation

$$E [ {\sum }_{k ∈ \{ k : {t}_{i , k}^{e} ∈ [ a , b - {τ}_{i , k} ] \& {t}_{i , k}^{l} ∈ [ a , b - {τ}_{i , k} ] \}} {d}_{i , k} \times {τ}_{i , k} ]$$

may equal Σₜ₊ₐ^{b} \hat{X}_{i,t} for all a,b (0≦a<b≦T).

TABLE I
PROFILE OF JOBS IN A HOUSEHOLD.

| | Avg power | Avg duration | Avg frequency |
|---|---|---|---|
| Job name | (W) | (sec) | (times/day) |
| Oven | 1840 | 330 | 2.44 |
| Dishwasher | 450 | 7020 | 0.23 |
| Refrigerator | 42 | 86400 | 0.67 |
| Kitchen Outlet | 16 | 86400 | 2.33 |
| Lighting | 81 | 210 | 123.32 |
| Washer Dryer | 267 | 1590 | 0.68 |
| Microwave | 1580 | 30 | 8.6 |
| Bathroom | 1618 | 210 | 0.82 |
| Stove | 593 | 210 | 0.36 |
| Disposal | 28 | 60 | 0.36 |
| Furnace | 610 | 570 | 6.88 |
| Sub-panal | 239 | 3510 | 0.63 |
| Air-conditioner | 4 | 3480 | 9.32 |

For simplicity, it may be assumed that all jobs have constant instantaneous power consumption (average power may replace instantaneous power for simplicity) and constant duration. It should be appreciated that if the power consumption and duration of a job are assumed to be random, Gamma distribution can be used to model them because power consumption and duration may be positive-real-valued and Gamma distribution may have a support of (0, ∞) and may be versatile in modeling various shape of distribution. For the same household i used in Algorithm 4, the real-world power measurements of each job of Household i may be used. The average power, duration, and frequency of each job for one of the six households are listed in Table I. It should be appreciated that each of the six real-world households may have such a table of job profile, which may result in six different tables of job profile. To save space, only one household's job profile is listed in Table I.

To generate the earliest starting time of each job of the j-th type for User i, an exponential distribution may be used to generate the interval between two consecutive jobs of the same type (j-th type), denoted by βⱼ. That is, the probability density function of βⱼ may be

p(βⱼ)=λⱼe^{-λ}^{ⱼ}^{β}^{ⱼ} (6)

where λⱼ may be the average frequency of the j-th type of job, i.e., a value in the fourth column of Table I. Since λⱼ may be in units of times/day, βⱼ may be in units of one day (24 hours). The first β_{j,1} may be generated using the distribution in (6). If β_{j,1}≧1 day, no job may be generated for the j-th type of job for this user, and another type of job may be generated; otherwise, let t_{i,1}^{e}=β_{j,1} and the second β_{j,2} may be generated. If t_{i,1}^{e}+β_{j,2}≧1 day, then t_{i,1}^{l}=1−τ_{i,j} (where τ_{i,j} may be the duration of the j-th type of job of User i and is in the third column of Table I) and another type of job may be generated; otherwise let t_{i,2}^{e}=t_{i,1}^{e}+β_{j,2} and t_{i,1}^{l}=t_{i,2}^{e}−τ_{i,j}. This process may be repeated for each type of job for this user until

$$E [ {\sum }_{k ∈ \{ k : {t}_{i , k}^{e} ∈ [ a , b - {τ}_{i , k} ] \& {t}_{i , k}^{l} ∈ [ a , b - {τ}_{i , k} ] \}} {d}_{i , k} \times {τ}_{i , k} ] = {\sum }_{t = a}^{b} {\hat{X}}_{i , t}$$

for all a,b (0≦a<b≦T). A preferable difference may be b−a=10 minutes.

Network Topology Simulator

To evaluate the performance of the clustering scheme according to some embodiments, the widely-used LFR random network generator may be used [10, 11] to generate large-scale realistic social network topologies, which may have the following properties: 1) the node degree may follow a power law distribution, and 2) the distribution of cluster/community sizes may also follow a power law distribution. It may be assumed that there are 1000 households in the system. The LFR network generator may therefore be used to generate a small-world scale-free network of 1000 nodes, representing a social network.

Measurement Data

The trace-driven simulator according to some embodiments may use real-world electricity consumption measurements as input. From [8, 12], a set of several weeks of power data for 6 different homes may be obtained, including two types of power data: 1) the whole household power consumption measured at a rate of 1 Hz, and 2) power consumption of up to 24 individual appliances in a home, measured at a rate of 0.5 Hz. Using the power measurements of each appliance in a household, Table I may be obtained and used as job profiles.

Generation of Household Electricity Consumption Data

Algorithm 4 may take the power measurements of each of the six household as input to generate 200 electricity consumption processes {\hat{X}_{i,t}} (i=1, . . . ,200; t=1, . . . , Tₓ). Because power measurements of six households may be given, a total of 1200 electricity consumption processes may be generated. As there are 1000 households in the system, 1000 out of the 1200 processes may be randomly picked and each selected process may be assigned to one household in the social network.

Generation of Job Demand Profile Data

Given {\hat{X}_{i,t}} and Table I, the job demand profile simulator may generate job demand profiles for each of the 1000 households in the social network.

Energy Pricing Model

To evaluate how much cost is saved under the proposed scheme according to some embodiments, an energy pricing model may be used to convert user power consumption into user payment. A quadratic pricing model [2] may be used as below

Cₜ=r×(Lₜ)², (7)

where Cₜ may be the price/user-cost in time slot t, Lₜ may be the total load/energy-consumption in slot t, and r may be a rate. Because (7) may penalize more on large power consumption than on small power consumption, a load schedule that minimizes the peak power consumption may reduce the user cost at the same time. This pricing model has been used by utility companies as incentives for users to comply with peak-minimization load schedules.

### Exemplary Results

The following results indicate both the effectiveness of the techniques of distributed scheduling as described herein as well as indicate values of some parameters that may be used in accordance with some embodiments.

Accuracy of Trace-Driven Simulator

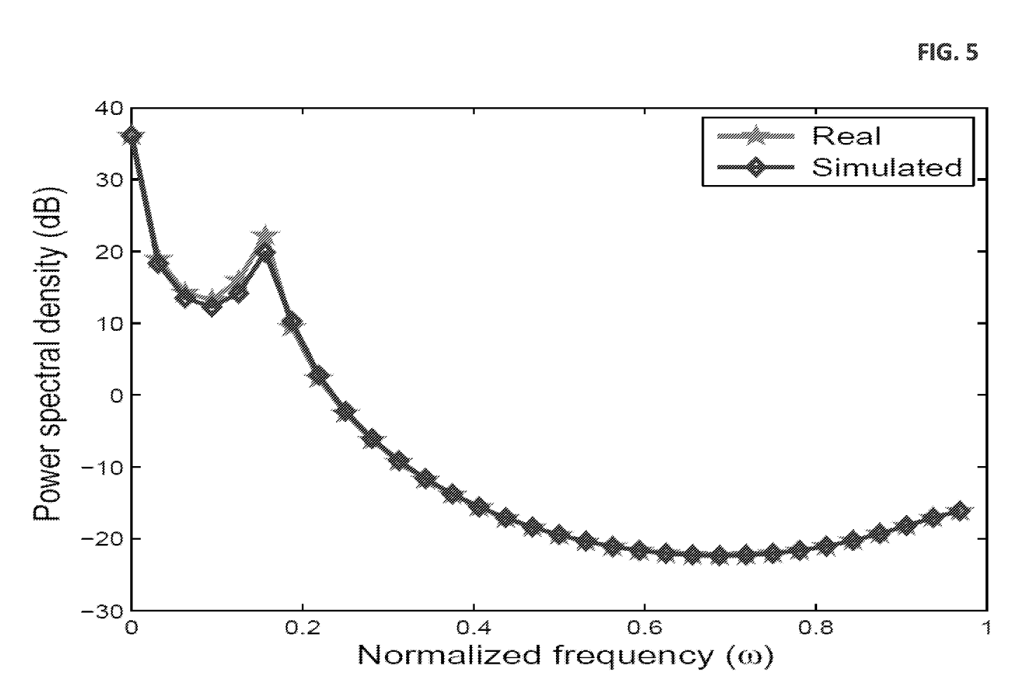

FIG. 5 shows the power spectral density (PSD) of the real-world data and the simulated data generated by Algorithm 4 according to some embodiments. It can be observed that the PSD of the simulated data may be considered very close to that of the real-world data, which may indicate high accuracy of Algorithm 4.

The following examples illustrate scenarios in which simulation may be used to evaluate the effects of the family plan scheme and related factors on various metrics.

### Example 1

### PAR and User Payment Under Family Plan Scheme

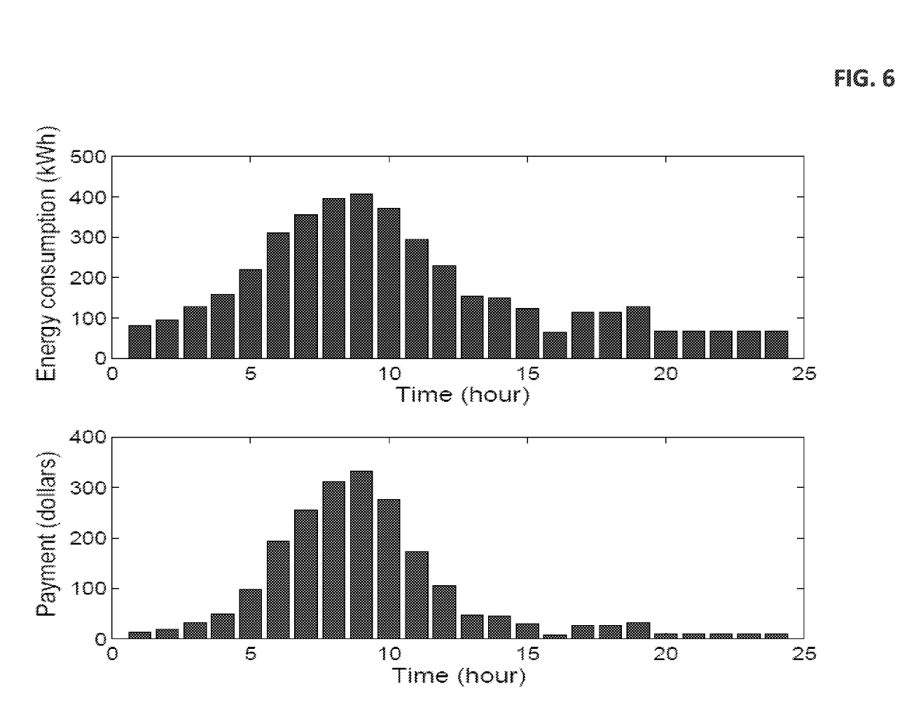

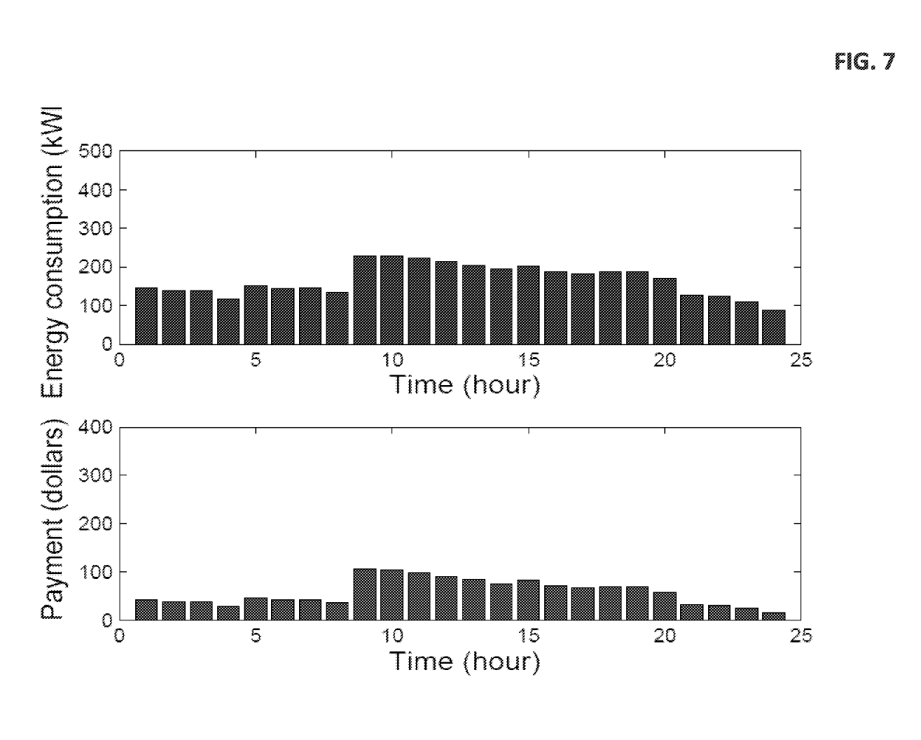

The family plan scheme according to some embodiments may be compared with the case of not using the family plan. FIG. 6 shows energy consumption and user payment as a function of time for the case of not using the family plan according to some embodiments. FIG. 7 shows energy consumption and user payment as a function of time for the family plan scheme according to some embodiments. The user payment/cost may be obtained by (7). As shown in FIG. 6, when the family plan scheme is not used, the PAR for 1000 households may be 2.68 and the total user payment may be $2945.40. In contrast, when the family plan scheme is used (under N_{c}=5), the PAR may reduce to 1.43 (46.6% less) and the total user payment may reduce to $1764.7 (40.1% less). In addition, when the family plan scheme is used, the load may become much smoother compared to no family plan.

### Example 2

### Fuel Cost Under Family Plan Scheme

To show the gain of reducing peak power consumption from the utility company perspective, the values in Tables 1 and 2 of [4] (reproduced below as Table II and Table III, respectively) may be used to compute the fuel cost for one million households. One million households may be considered because that number may meet the output power of a power generator, whereas the demand of 1000 households may not be sufficient to meet the minimum power generated by a power generator in Table II.

TABLE II
CHARACTERISTICS OF GENERATORS.

| Unit | Minimum power (MW) | Maximum power (MW) |
|---|---|---|
| G₁ | 50 | 250 |
| G₂ | 50 | 200 |

TABLE III
FUEL DATA.

| | | | | Start-up | Fuel |
|---|---|---|---|---|---|
| | a | B | C | fuel | price |
| Unit | (MBtu) | (MBtu/MWh) | (MBtu/M M² h) | (MBtu) | ($/MBtu) |
| G₁ | 0.0024 | 12.33 | 28 | 1500 | 1 |
| G₂ | 0.0044 | 13.29 | 39 | 1500 | 1 |

It may be assumed that two thermal generators may provide power for one million households. It may be assumed that the energy consumption of users may scale with the number of users, and so the energy consumption of these one million households may be simply 1000 times the energy consumption of the thousand households obtained in the paragraph above. From Table III, Generator G₁ may cost less than Generator G₂ if both produce the same amount of power. Accordingly, as long as G₁ can satisfy the demand, G₁ may be used instead of G₂. Let Lₜ denote the power demand/load in time slot t. If Lₜ≦250 MW, only G₁ may be on. The amount of fuel needed [4] may be a+b×Lₜ+c×Lₜ²=0.0024+12.33Lₜ+28Lₜ² (MBtu) and it may cost 0.0024+12.33Lₜ+28Lₜ² dollars because 1 MBtu may cost 1 dollar according to Table III. When Lₜ becomes larger than 250 MW, G₂ may also need to be activated and the cost of start-up fuel 1500 (MBtu) may need to be added. If 250<Lₜ≦450, both G₁ and G₂ may need to be on. Because G₁ may have higher efficiency than G₂, G₁ may produce 250 MW and G₂ may produce (Lₜ−250) MW, and the cost of fuel may be 0.0024+12.33×250+28×250²+0.0044+13.29(Lₜ−250)+39(Lₜ−250)². If Lₜ>450, some load may have to be shed.

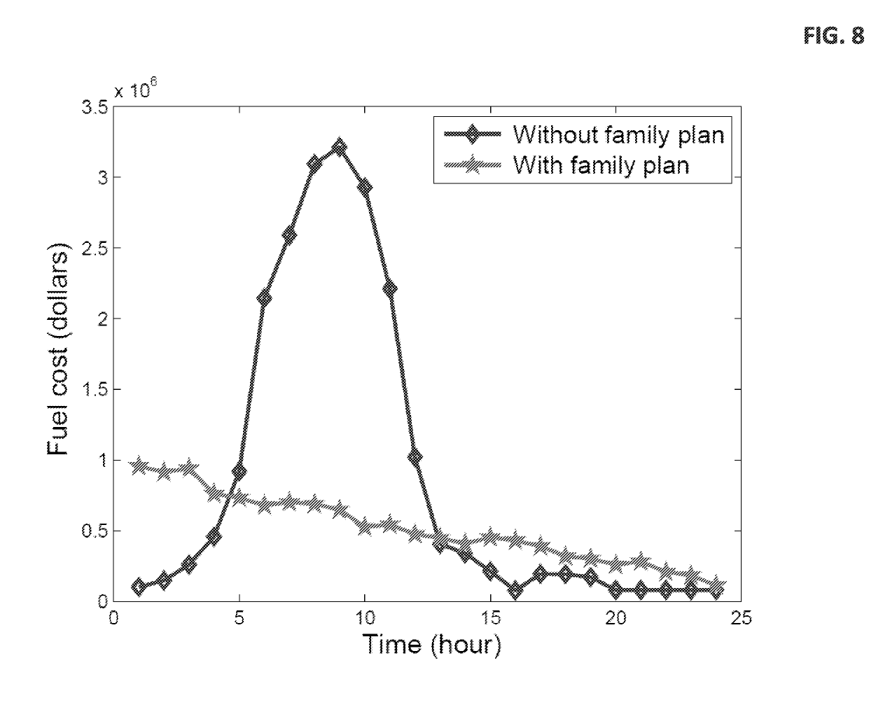

Using the same energy consumption of the thousand households obtained above (magnified by 1000 times), the fuel cost in each hour may be calculated, shown in FIG. 8. In 24 hours, the total fuel cost for no family plan may be $21,343,000; and the total fuel cost under the family plan according to some embodiments may be $11,265,000. The family plan approach thus may save 47.22% in fuel cost.

### Example 3

### Effect of N_{c}

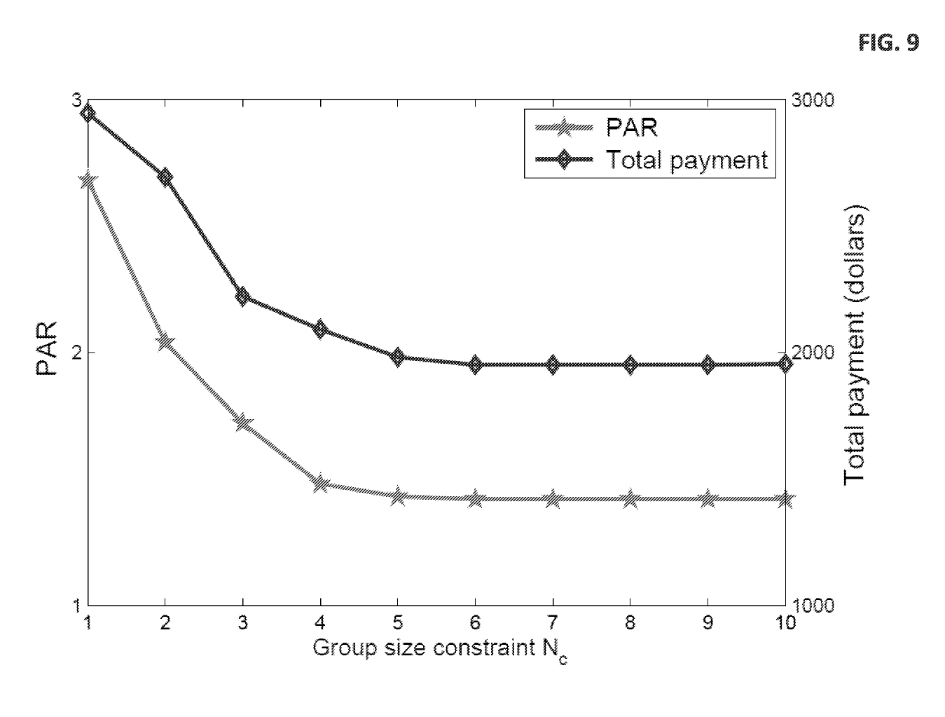

The effect of cluster size constraint N_{c} on the performance of the family plan scheme according to some embodiments may be considered. FIG. 9 shows PAR and user payment as a function of N_{c} for the family plan scheme according to some embodiments. The case for N_{c}=1 may correspond to no family plan. It can be observed that the larger N_{c}, the lower PAR may be and the lower user payment may be. This may be because the larger the cluster size, the more jobs to be scheduled, which may result in lower PAR under the peak-minimizing scheduler according to some embodiments. A “catch” may be that the strategy for clustering may need to be carefully selected: random clustering+peak-minimizing scheduling may not be optimal and may be improved upon by minimum-variance clustering+peak-minimizing scheduling.

### Example 4

### Minimum-Variance Clustering Vs. Random Clustering

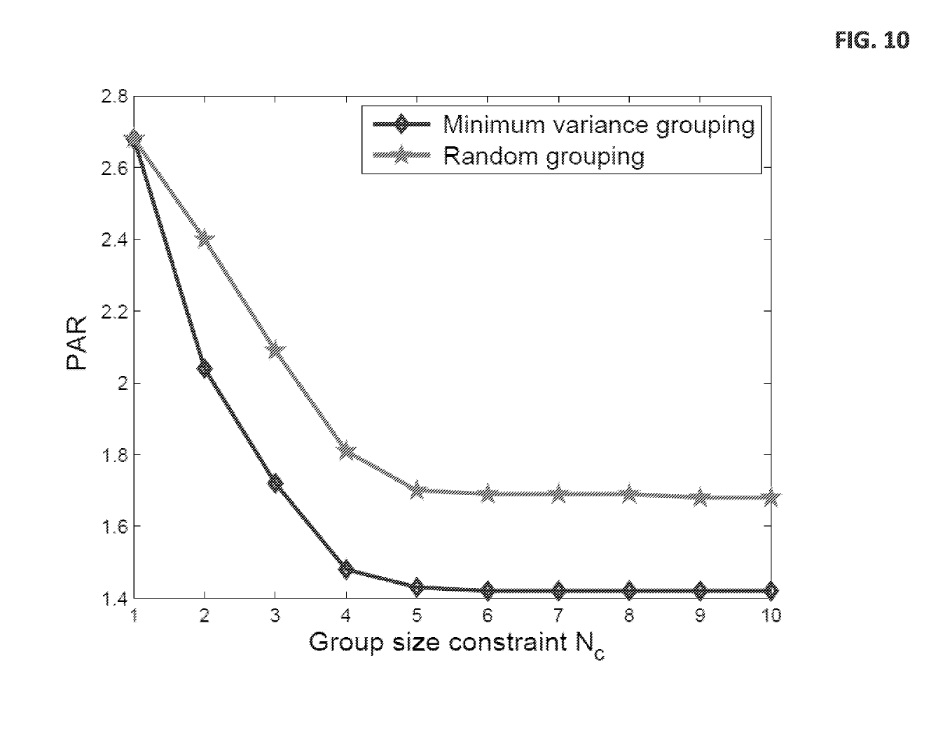

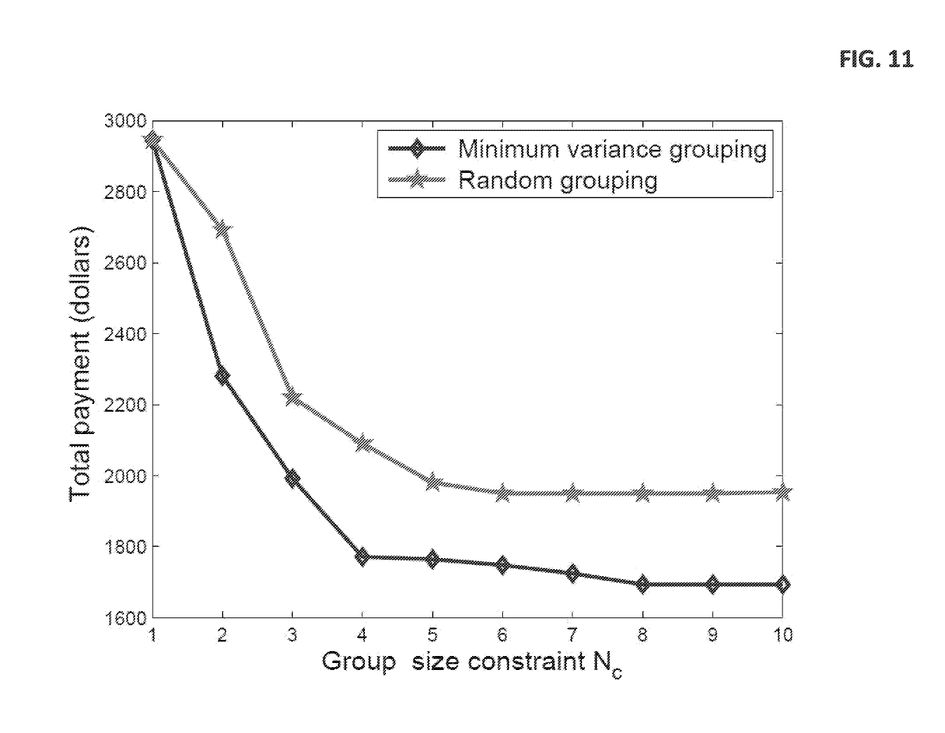

The performance of random clustering+peak-minimizing scheduling with minimum-variance clustering+peak-minimizing scheduling may be compared. FIG. 10 shows PAR as a function of N_{c} for the minimum-variance clustering according to some embodiments and the random clustering. FIG. 11 shows user payment as a function of N_{c} for the minimum-variance clustering according to some embodiments and the random clustering. It can be observed that the minimum-variance clustering achieve much better performance than the random clustering. For N_{c}=3, the minimum-variance clustering may help reduce PAR and user payment by 17.0% and 11.6%, respectively, compared to random clustering. The reason for this performance gain may be that unlike random clustering, the minimum-variance clustering according to some embodiments may tend to place users of different electricity usage patterns into the same cluster, which may mean the periods of high power consumption of different users are less likely to overlap, making the peak-minimizing scheduler easy to schedule jobs to achieve low peak demand. For example, under the minimum-variance clustering according to some embodiments, a household that usually has high power usage between 3 pm and 7 pm may be clustered with another household that usually has high power usage between 7 pm and 11 pm; then the peak-minimizing scheduler according to some embodiments can easily achieve a large reduction in peak power consumption. In contrast, under random clustering, two households with the same peak usage hour may be placed in the same cluster; the peak-minimizing scheduler may not achieve a low peak demand because many jobs of the two households may need to be scheduled within the same hour—there may be little room to shift jobs within this peak hour even if some other time periods have no jobs. However, this may be unlikely to happen under the minimum-variance clustering according to some embodiments because clustering two households with the same peak period will result in very high variance.

### Example 5

### EDF Scheduling Vs. No Scheduling

How much gain the EDF scheduling (i.e., Algorithm 1) can achieve compared to no scheduling may be evaluated. Here, no scheduling means that the users can run the jobs at will (without any coordination), i.e., each job Jᵢ is randomly assigned with a starting time sᵢ which is uniformly distributed in [tᵢ^{e}, tᵢ^{l}]. Two cases may be considered.

Case 1: tᵢ^{e}=0 and tᵢ^{l}=T−τᵢ (∀i). T=24 hours. Case 1 may represent the most flexible constraint, that is, each job may have the maximum flexibility/range, i.e., [0,T−τᵢ], for scheduling.

Case 2: tᵢ^{l}−tᵢ^{e}≦2 hours (Vi). Case 2 may represent a more stringent constraint, i.e., each job may be scheduled within an interval of two hours.

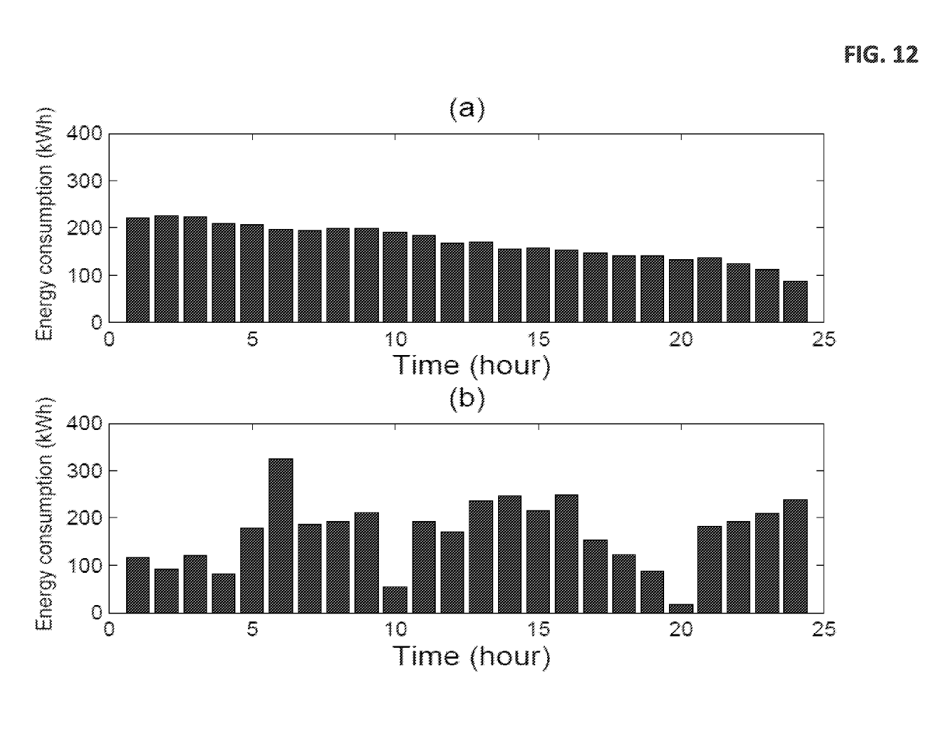

FIG. 12 shows energy consumption as a function of time for Case 1 under the EDF scheduling according to some embodiments and no scheduling, respectively. The PAR values for the EDF scheduling and no scheduling may be 1.34 and 1.99, respectively. The EDF scheduling may therefore reduce PAR by 32.67% compared to no scheduling. FIG. 12 shows energy consumption and user payment as a function of time for Case 2 under the EDF scheduling according to some embodiments and no scheduling, respectively. The PAR values for the EDF scheduling and no scheduling may be 1.43 and 1.59, respectively. The EDF scheduling may therefore reduce PAR by 10.06% compared to no scheduling. It can be observed that the smaller interval of [tᵢ^{e}, tᵢ^{l}] is, the less PAR reduction may be. This may be because the smaller interval of [tᵢ^{e},tᵢ^{l}] is, the less room to shift jobs around under the EDF scheduling may be.

### REFERENCES

The following references are incorporated herein by reference in their entireties:
[1] L. Perez-Lombard, J. Ortiz, and C. Pout, “A review on buildings energy consumption information,” Energy and buildings, vol. 40, no. 3, pp. 394-398, 2008.
[2] A.-H. Mohsenian-Rad, V. W. Wong, J. Jatskevich, and R. Schober, “Optimal and autonomous incentive-based energy consumption scheduling algorithm for smart grid,” in Innovative Smart Grid Technologies (ISGT). 1 em plus 0.5 em minus 0.4 em IEEE, 2010, pp. 1-6.
[3] S. Tang, Q. Huang, X.-Y. Li, and D. Wu, “Smoothing the energy consumption: Peak demand reduction in smart grid,” in Proceedings of IEEE INFOCOM, 2013, pp. 1133-1141.
[4] R. Jiang, J. Wang, and Y. Guan, “Robust unit commitment with wind power and pumped storage hydro,” IEEE Transactions on Power Systems, vol. 27, no. 2, pp. 800-810, 2012.
[5] www.att.com/shop/wireless/plans/familyplans.html.
[6] U. Von Luxburg, “A tutorial on spectral clustering,” Statistics and computing, vol.
17, no. 4, pp. 395-416, 2007.
[7] L. Schenato and G. Gamba, “A distributed consensus protocol for clock synchronization in wireless sensor network,” in 46th IEEE Conference on Decision and Control,
2007, pp. 2289-2294.
[8] http://redd.csail.mit.edu/.
[9] P. J. Brockwell and R. A. Davis, Time series: theory and methods. 1 em plus 0.5 em minus 0.4 em Springer, 1991.
[10] A. Lancichinetti, S. Fortunato, and F. Radicchi, “Benchmark graphs for testing community detection algorithms,” Physical Review E, vol. 78, no. 4, p. 046110, 2008.
[11] https://sites.google.com/site/andrealancichinetti/files.
[12] J. Z. Kolter and M. J. Johnson, “Redd: A public data set for energy disaggregation research,” in Proceedings of the KDD Workshop on Data Mining Applications in Sustainability, 2011, pp. 1-6.
[13] S. Caron and G. Kesidis, “Incentive-based energy consumption scheduling algorithms for the smart grid,” in 1st IEEE International Conference on Smart Grid Communications (SmartGridComm), 2010, pp. 391-396.
[14] Y. Guo, Z. Ding, Y. Fang, and D. Wu, “Cutting down electricity cost in internet data centers by using energy storage,” in IEEE Global Telecommunications Conference (GLOBECOM), 2011.
[15] Q. Zhu, F. M. David, C. F. Devaraj, Z. Li, Y. Zhou, and P. Cao, “Reducing energy consumption of disk storage using power-aware cache management,” in Proceedings of IEEE Software, 2004, pp. 118-118.
[16] J. S. Chase, D. C. Anderson, P. N. Thakar, A. M. Vandat, and R. P. Doyle, “Managing energy and server resources in hosting centers,” in ACM SIGOPS Operating Systems Review, vol. 35, no. 5, 2001, pp. 103-116.
[17] S. E. Schaeffer, “Graph clustering,” Computer Science Review, vol. 1, no. 1, pp. 27-64, 2007.
[18] R. Xu, D. Wunsch et al., “Survey of clustering algorithms,” IEEE Transactions on Neural Networks, vol. 16, no. 3, pp. 645-678, 2005.
[19] A. Nusairat and X. Li, “WiMAX/OFDMA burst scheduling algorithm to maximize scheduled data,” IEEE Transactions on Mobile Computing, 2011.
[20] D. Ye and G. Zhang, “On-line scheduling of parallel jobs,” in Structural Information and Communication Complexity. 1 em plus 0.5 em minus 0.4 em Springer, 2004, pp. 279-290.
[21] M. He, S. Murugesan, and J. Zhang, “Multiple timescale dispatch and scheduling for stochastic reliability in smart grids with wind generation integration,” in Proceedings of IEEE INFOCOM, 2011, pp. 461-465.
[22] Y. Huang, S. Mao, and R. Nelms, “Adaptive electricity scheduling in microgrids,” Proceedings of IEEE INFOCOM, 2013.
[23] K. Jansen and G. Zhang, “On rectangle packing: maximizing benefits,” in Proceedings of the 15th annual ACM-SIAM symposium on Discrete algorithms. 1 em plus 0.5 em minus 0.4 em Society for Industrial and Applied Mathematics, 2004, pp. 204-213.
[24] B. S. Baker and J. S. Schwarz, “Shelf algorithms for two-dimensional packing problems,” SIAM Journal on Computing, vol. 12, no. 3, pp. 508-525, 1983.
[25] J. Zhao, T. Jung, Y. Wang, and X.-Y. Li, “Achieving Differential Privacy of Data Disclosure in the Smart Grid,”, in Proceedings of IEEE INFOCOM, 2014.

### Computing Environment

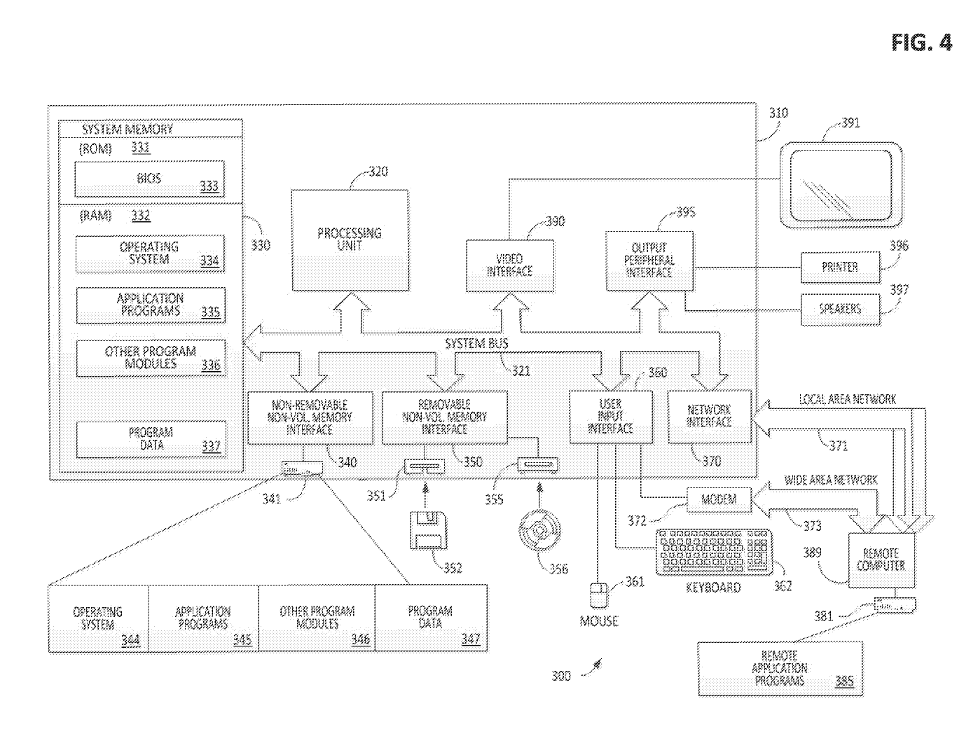

Control techniques to generate or use a regulation system at a user premises may be implemented on any suitable hardware, including a programmed computing system. For example, FIG. 1 illustrates a system implemented with multiple computing devices, which may be distributed and/or centralized. Also, FIGS. 2 and 3 illustrate algorithms executing on at least one computing device. FIG. 4 illustrates an example of a suitable computing system environment 300 on which embodiments of these algorithms may be implemented. This computing system may be representative of a computing system that implements the described technique of reducing peak power consumption. However, it should be appreciated that the computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments or cloud-based computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 4, an exemplary system for implementing the invention includes a general purpose computing device in the form of a computer 310. Though a programmed general purpose computer is illustrated, it should be understood by one of skill in the art that algorithms may be implemented in any suitable computing device. Accordingly, techniques as described herein may be implemented in a system for reducing peak power consumption. These techniques may be implemented in such controllers as originally manufactured or as a retrofit, such as by changing program memory devices holding programming for such controllers or software download. Thus, some or all of the components illustrated in FIG. 4, though illustrated as part of a general purpose computer, may be regarded as representing portions of a controller or other component in a peak power consumption reduction system.

Components of computer 310 may include, but are not limited to, a processing unit 320, a system memory 330, and a system bus 321 that couples various system components including the system memory 330 to the processing unit 320. The system bus 321 may be any of several types of bus structures including a memory bus or memory controller, a peripheral bus, and a local bus using any of a variety of bus architectures. By way of example and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can by accessed by computer 310. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example and not limitation, communication media includes wired media such as a wired network or direct-wired connection, and wireless media such as acoustic, radio frequency (RF), infrared (IR), and other wireless media. Combinations of any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example and not limitation, FIG. 4 illustrates operating system 334, application programs 335, other program modules 336, and program data 337.

The computer 310 may also include other removable/non-removable, volatile/nonvolatile computer storage media. By way of example only, FIG. 4 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through an non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 4, provide storage of computer readable instructions, data structures, program modules, and other data for the computer 310. In FIG. 4, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as a keyboard 362 and pointing device 361, commonly referred to as a mouse, trackball, or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port, or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device, or some other common network node, and typically includes many or all of the elements described above relative to the computer 310, although only a memory storage device 381 has been illustrated in FIG. 4. The logical connections depicted in FIG. 4 include a local area network (LAN) 371 and a wide area network (WAN) 373, but may also include other networks. Such networking environments are commonplace in offices, enterprise-wide computer networks, intranets, and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example and not limitation, FIG. 4 illustrates remote application programs 385 as residing on memory device 381. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating a system to reduce peak power consumption of a plurality of users, the method comprising:
forming at least one cluster of the plurality of users based on:
connections within a social network system between the plurality of users, and
energy usage patterns of the plurality of users; and
scheduling jobs for at least one user within the at least one cluster to reduce peak power used within the at least one cluster.

2. The method of claim 1, wherein forming the at least one cluster of the plurality of users comprises iteratively building the at least one cluster.

3. The method of claim 2, wherein iteratively building the at least one cluster comprises iteratively adding at least one available user to the at least one cluster.

4. The method of claim 1, wherein the energy usage patterns of the plurality of users comprise a variance of total power consumed by the at least one user within the at least one cluster over a time period.

5. The method of claim 4, wherein the at least one cluster is formed so as to minimize the variance.

6. The method of claim 1, wherein scheduling comprises receiving job schedule information of the at least one user within the at least one cluster from the at least one user.

7. The method of claim 6, wherein scheduling further comprises sending job schedule information of the at least one user within the at least one cluster to at least one other user within the at least one cluster.

8. The method of claim 1, wherein scheduling comprises determining time of operation of appliances at premises of the at least one user within the at least one cluster.

9. The method of claim 8, wherein scheduling further comprises electronically communicating operating time information to electrical equipment at the premises of the at least one user within the at least one cluster.

10. The method of claim 1, wherein scheduling comprises arranging in time a first job and a second job based on an earliest start time, a latest start time, a duration, and a power demand of the first job and an earliest start time, a latest start time, a duration, and a power demand of the second job.

11. At least one computer-readable storage medium encoded with executable instructions that, when executed by at least one processor, cause the at least one processor to perform a method for reducing peak power consumption of a plurality of users, the method comprising:
participating in formation of a cluster from the plurality of users by:
sending energy usage patterns of a first user of the plurality of users to at least one second user of the plurality of users, and
receiving energy usage patterns of the at least one second user,
wherein the formation of the cluster is based on:
connections between the first user and the at least one second user within a social network system, and
the energy usage patterns of the first user and the energy usage patterns of the at least one second user; and
scheduling at least one job for the first user to reduce peak power used within the cluster.

12. A method for reducing peak power consumption of a plurality of users, the method comprising:
participating in formation of a cluster from the plurality of users by:
sending energy usage patterns of a first user of the plurality of users to at least one second user of the plurality of users, and
receiving energy usage patterns of the at least one second user,
wherein the formation of the cluster is based on:
connections between the first user and the at least one second user within a social network system, and
the energy usage patterns of the first user and the energy usage patterns of the at least one second user; and
scheduling at least one job for the first user to reduce peak power used within the cluster.

13. The method of claim 12, wherein receiving the energy usage patterns of the at least one second user comprises receiving the energy usage patterns of the at least one second user from the at least one second user.

14. The method of claim 12, wherein the at least one second user comprises at least one neighbor of the first user.

15. The method of claim 14, wherein the at least one neighbor of the first user comprises at least one user connected to and trusted by the first user.

16. The method of claim 12, wherein the formation of the cluster comprises iterative addition of available users to the cluster.

17. The method of claim 12, wherein the energy usage patterns of the first user and the energy usage patterns of the at least one second user comprise a variance of total power consumed by the first user and the at least one second user over a time period.

18. The method of claim 17, wherein the formation of the cluster occurs such that the variance is minimized.

19. The method of claim 12, wherein scheduling comprises sending job schedule information of the first user to other users within the cluster.

20. The method of claim 19, wherein scheduling further comprises receiving job schedule information of the other users within the cluster from the other users.

21. The method of claim 12, wherein scheduling comprises determining time of operation of appliances at premises of the first user and premises of other users within the cluster.

22. The method of claim 21, wherein scheduling further comprises electronically communicating operating time information to electrical equipment at the premises of the first user.

23. The method of claim 12, wherein scheduling comprises arranging in time a first job and a second job based on an earliest start time, a latest start time, a duration, and a power demand of the first job and an earliest start time, a latest start time, a duration, and a power demand of the second job.
